(19) United States
(12) Patent Application Publication
(10) Pub. No.: US 2001/0039867 A1
(43) Pub. Date: Nov. 15, 2001

(54) Quick-extraction punch-holder adaptor for converting punching machines from a single-punch to a multiple-punch configuration

(76) Inventor: Giorgio Ostini, Grono (CH)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/843,988

(22) Filed: Apr. 27, 2001

(30) Foreign Application Priority Data
May 11, 2000 (GB) 0011424.9

(51) Int. Cl. B26D 5/08

(52) U.S. Cl. 83/552; 83/582; 83/698.91

(57) ABSTRACT

A quick-extraction punch-holder adaptor for converting punching machines from a single-punch to a multiple-punch configuration, connectable to a conventional turret of a punching machine, comprises a cylindrical body crossed by a plurality of punch accommodation receptacles, a selection device rotatably mounted at the end of the cylindrical body and provided, at a lower face, with a tooth for contact with the head of each selected punch and elastic elements, circumferentially interposed between the selection device and the cylindrical body, and being loadable by compression to contrast the active stroke and produce the return of the punches.

### BACKGROUND OF THE INVENTION

The present invention relates to a quick-extraction punch-holder adaptor for converting punching machines from a single-punch to a multiple-punch configuration.

It is well-known that punching machines use bodies for accommodating the punches, known as punch-holders, employed to machine metal plates, which are located below the hammer and guide, over a stroke of preset extent, the punches when such hammer applies to them the blow that allows to work the metal plate.

These punch-holders are currently shaped so as to accommodate only one punch at a time; in fact they consist of a cylindrical body in which there is a through seat accommodating the punch that is used for a given process: a horizontal member shaped as a disk is mounted above the body, can move parallel to itself in a vertical direction, and supports on its lower face a mechanical coupling for engaging the head of the punch.

Two helical springs which can be loaded by compression are inserted between the lower face of the disk and the upper face of the body of the punch-holder, are arranged diametrically opposite, and are adapted to draw upwards the disk after punching and accordingly extract from the metal plate the punch that is engaged therein.

When a given process has to be modified, it is necessary to remove the punch used up to that time and replace it with the one that must perform the new process.

Moreover, it should also be noted that punches wear over time and in order to be used for long periods they are subjected to grinding or sharpening operations which vary their overall useful length.

This causes a variation in the stroke that the hammer must perform in order to execute complete punching; a few millimeters of this variation can be compensated by acting on the adjustment of the stroke of the hammer.

The above-described prior art suffers some drawbacks. A first one is the fact that replacement of each punch is very complicated and time-consuming.

A second drawback is that the extraction force offered by the springs that are used is substantially limited, so that after the active step for the descent of the punch, the punch can jam in the metal plate it has just perforated, consequently requiring intervention by an assigned operator who manually extracts, by using adapted tools, the punch from the metal plate, with a significant waste of time and with the necessity to stop the punching machine.

A third drawback is that the punches, after a limited number of grindings to restore the surfaces that bite into the metal plates, must be replaced completely because their shortening can no longer be compensated by adjusting the stroke of the hammer.

### SUMMARY OF THE INVENTION

The aim of the present invention is to solve the above-noted drawbacks of the prior art by providing a quick-extraction punch-holder adaptor for converting punching machines from a single-punch to a multiple-punch configuration which allows to have a plurality of punches available below the hammer without having to systematically resort to replacing them every time the process to be performed on the metal plates changes, which also allows to remove the punch that is used from the punched metal plates in an absolutely reliable way and without jamming, and which finally allows to compensate for variations in the length of the punches due to grinding operations repeated over time.

These and other objects which will become better apparent hereinafter are achieved by a quick-extraction punch-holder adaptor for converting punching machines from a single-punch to a multiple-punch configuration, characterized in that it comprises a cylindrical body being crossed by a plurality of receptacles for slidingly accommodating each punch with axes which are parallel to the axis of the cylindrical body, at the end of which a selection means is rotatably mounted, said selection means being provided, on its lower face, with a tooth for contact with the head of each selected punch and being engageable with a motor means for angularly controlled rotation, which is associated with the conventional turret of a punching machine, elastic means being circumferentially interposed between said selection means and said cylindrical body, the elastic means being loadable by compression and being adapted to contrast the active stroke and cause the return of the punches.

### BRIEF DESCRIPTION OF THE DRAWINGS

Further characteristics and advantages will become better apparent from the following detailed description of a preferred embodiment of a quick-extraction punch-holder adaptor for converting punching machines from single-punch to multiple-punch, illustrated only by way of non-limitative example in the accompanying drawings, wherein:

FIG. 1 is a partially sectional view, taken along a vertical plane, of the punch-holder adaptor according to the invention;

FIG. 2 is a reduced-scale bottom perspective view thereof;

FIG. 3 is a plan view, in phantom lines, of the adaptor according to the invention.

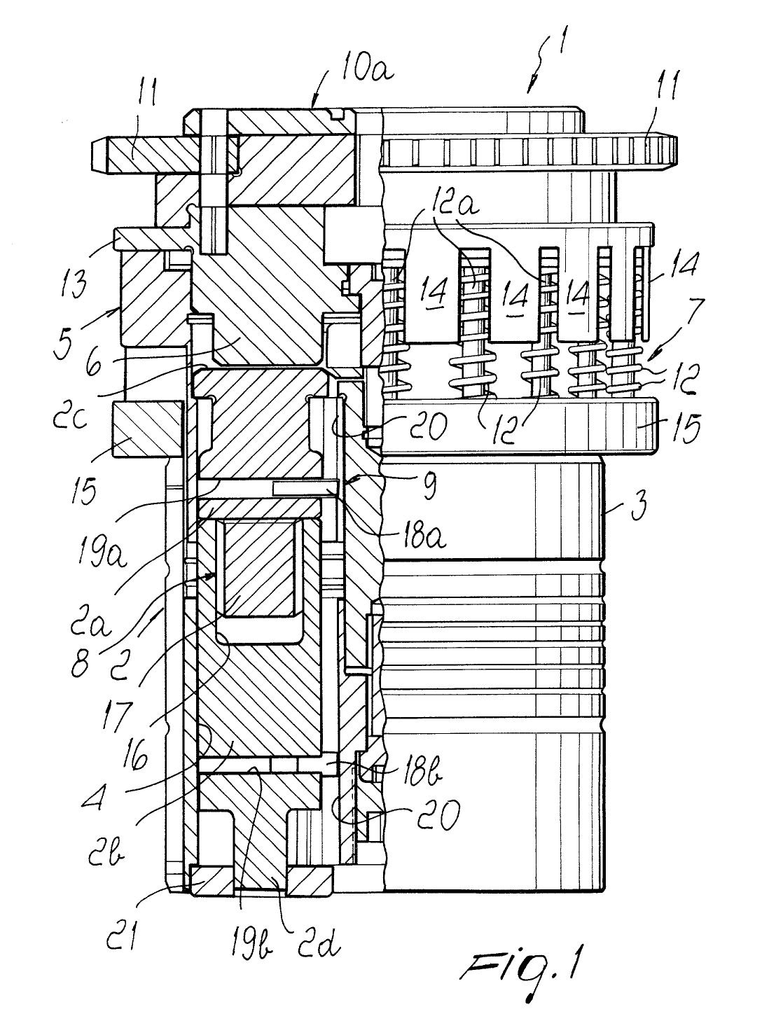

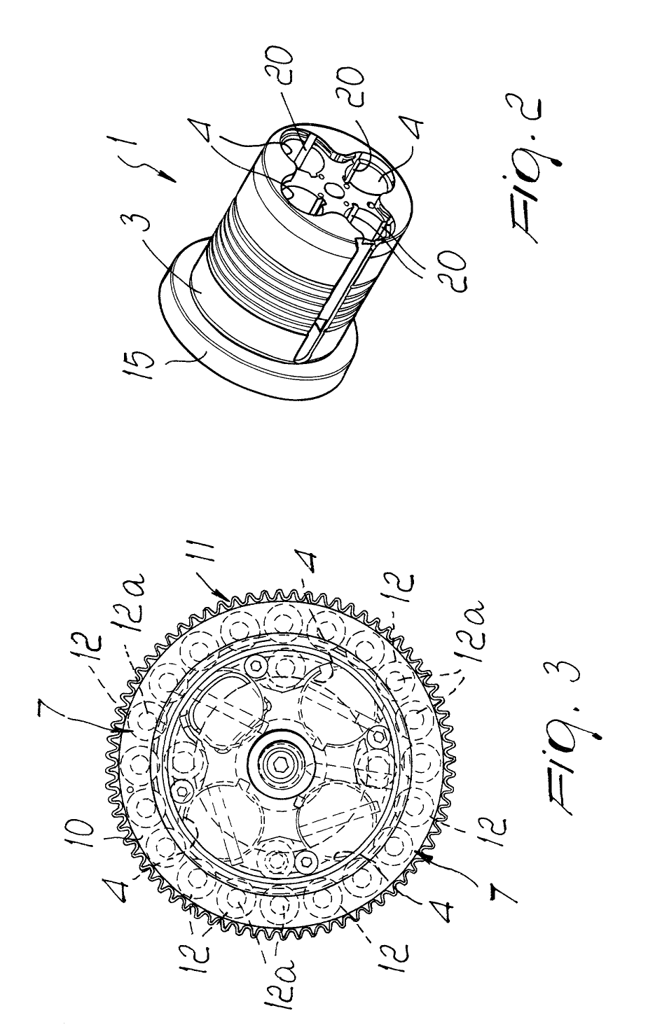

### DESCRIPTION OF THE PREFERRED EMBODIMENTS

With reference to the figures, 1 designates a quick-extraction punch-holder adaptor for converting punching machines from a single-punch to a multiple-punch configuration.

The adaptor 1 substantially comprises a cylindrical body 3 which is crossed by a plurality of receptacles 4, four in number in the specific case; each receptacle can slidingly accommodate a corresponding punch 2 with axes which are parallel to the axis of the cylindrical body 3.

At the end of the cylindrical body there is a rotatably fitted selection means 5 which has, on its lower face, a tooth 6 for contact with the head 2c of each selected punch 2; the selection means 5 can be coupled to a motor means of the conventional type, not shown in the drawings, which is adapted to produce its angularly controlled rotation; said motor means is associated with the conventional turret of the punching machine.

Elastic means 7 which can be loaded by compression are interposed circumferentially between the selection means 5 and the cylindrical body 3 and are adapted to contrast the active stroke and cause the return of each punch 2 after the active punching stroke.

Each punch 2 is advantageously composed of two coaxial cylindrical sections, respectively an upper one 2a and a lower one 2b, which are longitudinally interconnected by interposed fine-pitch screw means 8 for adjusting the overall lengths of the punches.

Means 9 for locking the rotation of the punches 2 about their axis inside the receptacles 4 are interposed between said punches and the corresponding seating receptacles 4.

The selection means 5 is constituted by a disk 10 which is coaxially supported at the end of the cylindrical body 2 and has, on its lower face, as mentioned earlier, the contact tooth 6 and, in a peripheral region, a toothed ring 11 for coupling with the rotary motion means.

The elastic means 7 which can be loaded by compression are constituted by a plurality of helical springs 12 being fitted on spring guiding pins 12a between a circumferential protrusion 13 of the disk 10, which also forms a vertical wall 14 for guiding and retention, and a step 15 which also protrudes circumferentially from the outer surface of the cylindrical body 2.

The disk 10 is mounted on the cylindrical body 2 so that it can move coaxially to it, with a useful stroke whose extent can be preset according to the type of punching to be performed and to the thickness of the metal plate to be punched.

The fine-pitch screw means 8 are constituted by a hollow cylindrical seat 16 which is formed in the lower section 2b of each punch 2; said seat is open upwards and is provided with an internal perimetric thread; a corresponding cylindrical pin 17 can be screwed snugly in each seat 16, is correspondingly and complementarily threaded on its perimeter and protrudes rigidly and coaxially from the upper section 2a of each punch 2.

Finally, the means 9 for locking the rotation of the punches 2 about their own axis are constituted by at least two pins 18a and 18b being inserted transversely in corresponding slots 19a and 19b which are formed respectively in the upper section 2a and in the lower section 2b of each punch 2; the pins 18a and 18b are mutually vertically aligned and, by protruding from the sides of said sections 2a and 2b, they couple to corresponding hollow slots 20 which are formed longitudinally in each hollow seat or receptacle 4; more specifically, there are three hollow slots 20 for each hollow seat or receptacle 4 and the slots are arranged at 120° to is each other in plan view.

As known, each one of the slots is closed in a downward region by a diaphragm 21 for extracting and guiding the shaped active portion 2d of the punch that is contained.

Operation of the invention is as follows: the adaptor 1 is inserted snugly in the provided seat of the upper turret of a punching machine in which a conventional single punch-holder is normally fitted.

A motor provided with a transmission sprocket which meshes with the toothed ring 11 of the disk 10 is further supported on said turret.

Corresponding punches 2 are arranged in the cylindrical body 3, each punch being arranged inside a corresponding hollow seat 4.

If the punches 2 are new, the upper section 2a and the lower section 2b are fully screwed together, i.e. the pin 17 is fully screwed into the seat 16, while if a punch 2 has been subjected beforehand to grinding of the active portion 2d, the upper portion 2a is turned by a preset number of turns so as to unscrew it with respect to the lower portion 2b, essentially increasing the total length of the ground punch 2 until it is returned to its original value.

When all the punches 2 are inserted in the respective seats 4, the transverse pins 18a and 18b, by sliding in the hollow slots 20 and therefore snugly coupling to them, prevent the punches from rotating about their own longitudinal axis; the motor of the turret of the punching machine then produces the angularly controlled rotation of the disk 10 until the tooth 6 reaches the punch 2 to be selected.

The selection is preset by an operator on the control panel of the punching machine and is performed by means of the electronic control logic which automatically controls the entire punching machine.

Correspondingly, a female die holder is inserted, flush with the supporting surface, in the footing on which the metal plate to be punched is rested; said dies are vertically aligned with the punches 2.

The hammer then performs its active stroke by pushing against the upper face 10a of the disk 10 which, by sliding vertically with respect to the cylindrical body 3 with a preset stroke, pushes, by means of the tooth 6, the selected punch 2 towards the metal plate to be punched, at the same time compressing all the springs 12 arranged circumferentially between the protrusion 13 and the step 15.

Once punching has been completed, the hammer rises again and the set of springs 12 extends again, forcefully extracting the punch from the metal plate.

In practice it has been observed that the above-described invention achieves the intended aim and objects, i.e. it allows to compensate for the lengths of the punches, returning them to their original values even after grinding, further allowing to have multiple punches available without resorting, at each change in punching, to the systematic replacement of the previously used punch, and finally to safely extract the punch without jamming after the active punching step, avoiding the blockage of the punching machine.

The invention thus conceived is susceptible of numerous modifications and variations, all of which are within the scope of the appended claims.

All the details may further be replaced with other technically equivalent ones.

In practice, the materials employed, as well as the shapes and the dimensions, may be any according to requirements without thereby abandoning the scope of the protection of the appended claims.

The disclosures in UK Patent Application No. 0011424.9 from which this application claims priority are incorporated herein by reference.

What is claimed is:

1. In a punching machine having a conventional turret and rotation actuation motor means, a quick-extraction punch-holder adaptor for converting the punching machine from a single-punch to a multiple-punch configuration, comprising: a cylindrical body having a longitudinal axis; a plurality of punches; a plurality of receptacles, provided at said cylindrical body, for slidingly accommodating each punch a respective one of said punches with axes thereof parallel to the axis of said cylindrical body; a selection means being rotatably mounted at an end of said cylindrical body and being engageable with said motor means for angularly controlled rotation thereof; a tooth, provided at a lower face of said selection means, for contacting a head part of a selected one of said punches; elastic means, which are circumferentially interposed between said selection means and said cylindrical body, said elastic means being loadable by compression and being adapted to contrast an active stroke of and produce return of said punches.

2. The adaptor of claim 1, wherein said punches are each composed of a fine-pitch screw means for adjusting lengths thereof and of two coaxial cylindrical sections which are longitudinally connected by interposition of said fine-pitch screw means.

3. The adaptor of claim 2, further comprising locking means for locking said punches so as to prevent rotation thereof about their axis in the respective said receptacles, said locking means being interposed between said punches and said receptacles.

4. The adaptor of claim 1, wherein said selection means is constituted by a disk which is supported coaxially at an end of said cylindrical body, said contact tooth being provided at the lower face of said disk, and by a toothed ring provided peripherically to said disk for coupling thereof to said rotation actuation motor means of the punching machine.

5. The adaptor of claim 4, wherein said disk has a circumferential protrusion which forms a vertical retention wall, and said cylindrical body has a step which protrudes circumferentially from an outer surface thereof, said elastic means, which are loadable by compression, being constituted by a plurality of helical springs inserted between said circumferential protrusion and said step.

6. The adaptor of claim 5, comprising spring guiding pins, turns of said springs being coiled around corresponding ones of said spring guiding pins.

7. The adaptor of claim 4, wherein said disk is fitted on said cylindrical body so as to be coaxially movable thereon by a useful extent with presettable dimensions.

8. The adaptor of claim 3, wherein said fine-pitch screw means of each one of said punches is constituted by a hollow cylindrical seat, which is formed in a lower one of said cylindrical sections of each punch, is open upwards and is provided with an internal perimetric thread, and by a corresponding cylindrical pin snugly screwable at said perimetric thread, said pin being complementarily threaded along a perimeter area thereof and protruding rigidly and coaxially from an upper one of said cylindrical sections, of each punch, screwing or unscrewing of said pin in the hollow cylindrical seat varying the axial length of the corresponding punch.

9. The adaptor of claim 8, further comprising seats formed in the upper section of each punch and hollow slots formed longitudinally in the wall of each receptacle for accommodating each punch, said locking means for preventing rotation of the punches about the axis thereof being constituted by at least one transverse pin, which is inserted in a corresponding one of said seats, said transverse pin being couplable to a corresponding one of said hollow slots.

10. The adaptor of claim 9, wherein in each receptacle for accommodating said punches, the hollow slots are three and are arranged at 120° to each other in plan view.
